(19) United States
(12) Patent Application Publication
(10) Pub. No.: US 2017/0350976 A1
(43) Pub. Date: Dec. 7, 2017

(54) METHOD FOR LOCATING A SUBMERGED OBJECT

(71) Applicants: ThyssenKrupp Marine Systems GmbH, Kiel (DE); thyssenkrupp AG, Essen (DE)

(72) Inventor: Peter Hauschildt, Melsdorf (DE)

(73) Assignees: ThyssenKrupp Marine Systems GmbH, Kiel (DE); thyssenkrupp AG, Essen (DE)

(21) Appl. No.: 15/535,849

(22) PCT Filed: Oct. 15, 2015
(86) PCT No.: PCT/EP2015/073859

§ 371 Date: Jun. 14, 2017

(30) Foreign Application Priority Data
Dec. 18, 2014 (DE) 10 2014 119 026.2

(51) Int. Cl. G01S 15/00; G01S 15/42

(52) U.S. Cl. CPC G01S 15/003; G01S 15/42

(57) ABSTRACT

A method for locating an object underwater may involve using a sound transmitter to transmit a sound pulse. The sound pulse may be reflected by the object to be located and then received by a sound receiver. The sound receiver may be spatially distant from the sound transmitter, meaning that the sound receiver is spaced apart from the sound transmitter by an amount that is of a similar order of magnitude as a distance between the sound transmitter and the object or between the sound transmitter and the seafloor. The sound pulse may contain encoded information relating to a time of transmission of the sound pulse and a transmission position of the sound transmitter. The encoded information may then be decoded by the sound receiver to determine the position of the object.

### PRIOR ART

The present invention concerns a method for locating an object underwater, wherein a sound transmitter transmits a sound pulse, the sound pulse is reflected and/or scattered at the object to be located and is received by a sound receiver spatially distant from the sound transmitter.

Methods of this sort are also known as bistatic sonar methods. They are used in the location of underwater targets by military surface and underwater vessels, in particular in the location of submarines. In such a method for bistatic sonar location, a sound transmitter, usually arranged on a surface vessel, transmits sound pulses which propagate through the water spreading out from the sound transmitter. If an object is located in the surroundings of the sound transmitter, the sound pulse is reflected by the object.

A submarine which is also located in the surroundings of the sound transmitter can receive the sound pulse reflected from the object. The submarine is usually fitted with a sound receiver for this purpose. To evaluate the sound pulse reflected at the object and received by the sound receiver, it is, however, advantageous to have precise knowledge of the position and the time at which the sound pulse was transmitted by the sound transmitter. In what is known as the non-cooperative method, the time of transmission and the position of transmission of the sound pulse are estimated by the sound receiver, which is, however, associated with a degree of imprecision in the location result. There is therefore a need, in particular in military applications in which a high precision of location is desired, to employ cooperative methods in which the time of transmission and position of transmission are conveyed to the receiver. In known cooperative methods, conveying the time of transmission and position of transmission is, for example, performed over an additional radio link between the surface vessel and the underwater vessel. This, however, entails the disadvantage that it is necessary for the underwater vessel to rise to periscope depth and to bring equipment that is suitable for the radio reception above the surface of the water. As a result, the submarine is itself relatively easily detectable.

### DISCLOSURE OF THE INVENTION

Against this background, it is the object of the present invention to reduce the detectability of the sound receiver.

The object is achieved by a method for locating an object underwater, wherein a sound transmitter transmits a sound pulse, the sound pulse is reflected at the object to be located and is received by a sound receiver spatially distant from the sound transmitter, wherein the sound pulse contains encoded information relating to the time of transmission of the sound pulse and the transmission position of the sound transmitter, which is decoded by the sound receiver from the sound pulse, in order to determine the position of the object.

In the method according to the invention, information relating to the time of transmission and to the position of the sound transmitter at the time of transmission is encoded by the sound transmitter in the sound pulse and transmitted. The sound receiver receiving the sound pulse can decode the received sound pulse, and thereby obtain information on the time of transmission and the transmission position, without it being necessary to provide an additional radio link between the sound transmitter and the sound receiver. Special apparatuses for radio reception on the part of the sound receiver, and a possible travel to periscope depth, can be omitted, so that the detectability of the sound receiver is reduced.

It can here be advantageously provided that the information encoded in the sound pulse is encrypted. By means of an encryption technology, known per se, the possibility that further sound receivers can use the encoded information can be excluded. The information relating to the position of the sound transmitter is thus not usable for countermeasures. It is, however, necessary for the use of encrypted encoding, that the encryption is coordinated between the sound transmitter and the sound receiver. Such a coordination typically takes place before the concrete use.

According to a preferred embodiment of the method, it is provided that the time of transmission of the sound pulse and the transmission position of the sound transmitter are encoded at the time of transmission together in the one sound pulse. Thus, even in the case of a plurality of sound pulses, each individual sound pulse contains both items of information.

According to a preferred embodiment of the method, it is provided that the sound receiver determines the time of reception of the sound signal. In addition, the sound receiver can determine the direction of reception from which the sound pulse is received, so that the receiver is able to draw conclusions as to the position of the object to be located. It is advantageous if the sound receiver is of a directionally sensitive design, so that the direction of reception can be determined, for example in comparison with a specified reference direction.

It has been found particularly preferable in this context if the sound receiver determines the position of the object to be located with reference to the transmission time, with reference to the transmission position, with reference to the reception time and with reference to the reception direction. It is possible, in addition to the information determined directly by the sound transmitter, namely the reception time and the reception direction, also to employ the information contained in the received sound pulse for the location of the object. The travel time of the sound pulse and the propagation path of the sound pulse can be calculated using the information that is contained in the sound pulse, so that the object can be located. In order to locate the object, it is not necessary, in addition to the sound pulse that is reflected at the object, to evaluate for example a further sound pulse transmitted on a direct path between the sound transmitter and the sound receiver (the so-called direct signal). Such direct signals can, however, be used additionally in order to improve the location of the object.

The method according to the invention is particularly suitable for those applications in which the sound transmitter moves with respect to the sound receiver. The sound transmitter and sound receiver can be arranged on different, mutually movable units.

The sound transmitter is preferably arranged on a water-going vessel. The water-going vessel can be a surface vessel, for example a ship or a boat, or can be an underwater vessel. Remotely controllable or autonomous surface or underwater vessels can be used. Alternatively, the sound transmitter can be arranged on an unmanned submersible or floating body, which entails the advantage that no crew are exposed to the danger that the sound transmitter is detected by enemy units. Such submersible or floating bodies can be implemented as buoys, beacons or torpedoes. As an alternative, the sound transmitter can be fastened to the seabed or to a bank.

It is advantageous if the sound receiver is arranged on an underwater vessel, in particular on a submarine.

A particularly advantageous embodiment of the method provides that the sound transmitter is released by the underwater vessel, in particular by the submarine. The sound transmitter can be arranged on a submersible or floating body that can be released by the underwater vessel and which is carried along on board the underwater vessel and can then be released when an object is to be located. The submersible or floating body can, for example, be released through a sluice or a barrel tube of the underwater vessel. Alternatively, the underwater vessel can comprise a receptacle arranged outside a pressure body of the underwater vessel, in which the submersible or floating body is held and from which it is released. Preferably the sound transmitter is not activated as it is released, and is activated after a prespecified period of time, so that a certain distance can be established between the sound transmitter and the underwater vessel before the sound transmitter is activated. The detectability of the underwater vessel can be further reduced in this way.

An embodiment in which the transmission position of the sound transmitter is determined by means of a satellite navigation system and/or by means of an inertial navigation system is advantageous, so that the position at the time of transmission can be determined by the sound transmitter and can be encoded in the sound pulse.

A further advantageous embodiment of the method according to the invention provides that a plurality of sound transmitters transmit a plurality of sound pulses which are reflected at the object to be located and are received by the sound receiver. The use of a plurality of sound pulses that originate from different sound transmitters permits a more precise location of the object that is reflecting the sound pulses. Since the sound pulses originating from different sound transmitters contain different information on the transmission time and transmission position, it is possible for the sound receiver to separate them.

In this connection it is preferable if the sound transmitters move with respect to one another, so that the sound pulses can meet the object to be located from varying directions. This can again increase the precision of the location.

Further details, features and advantages of the invention emerge from the drawings and from the following description of preferred forms of embodiment with reference to the drawings. The drawings here merely illustrate exemplary forms of embodiment of the invention which do not restrict the inventive idea.

### SHORT DESCRIPTION OF THE FIGURES

FIG. 1 shows a schematic illustration of the location of an object under water according to a first exemplary embodiment of the invention.

FIG. 2 shows a schematic illustration of the location of an object under water according to a second exemplary embodiment of the invention.

### FORMS OF EMBODIMENT OF THE INVENTION

The same parts are always given the same reference signs in the various figures, and are therefore in general also only named or explained once each.

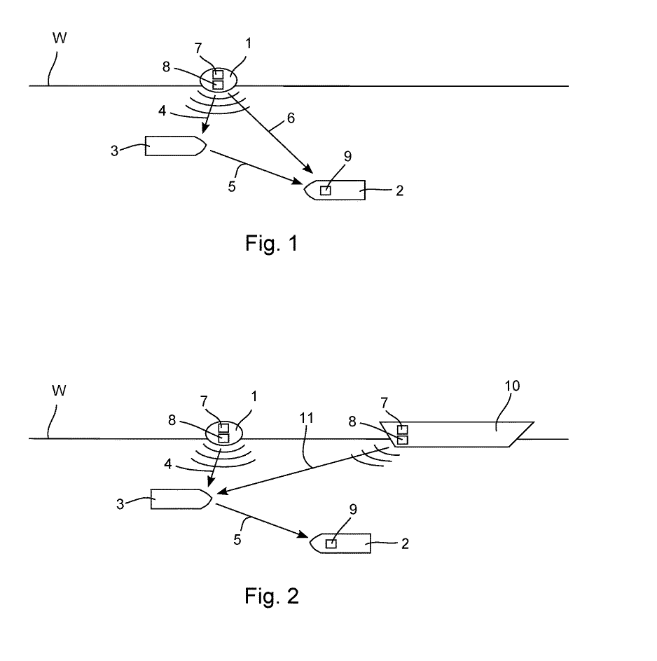

A first exemplary embodiment of a method according to the invention for locating an object under water is described below with reference to the illustration in FIG. 1. The method is a method for bistatic sonar location, wherein a sound transmitter 8 transmits a sound pulse that is often also referred to as a sonar ping. If an object 3 is located in the surroundings of the sound transmitter 8, the sound pulse radiated from the sound transmitter 8 is reflected at the object 3, and can be received by a sound receiver 9 that is arranged remotely from the sound transmitter 8. With bistatic sonar location it is neither necessary for the sound transmitter 8 and receiver 9 to be located physically close to one another, nor is it necessary for the sound transmitter 8 to have knowledge of the location of the sound receiver 9.

According to the present example, the sound transmitter 8 is arranged on board an unmanned floating body 1 similar to a buoy. The sound receiver 9 is located on board a military underwater vessel 2, which is implemented as a submarine. The underwater vessel 2 comprises a pressure body with a pressure-resistant design, and can accept a plurality of crew members. A floating body receptacle is provided outside the pressure body at the underwater vessel 2, in which the floating body 1 can be held and carried along. The floating body 1 is brought to a theater of operations in the floating body receptacle. Having arrived at the theater of operations, the floating body 2 is released, so that it distances itself from the underwater vessel 2 and rises to the water surface W. Alternatively or in addition to the floating body 1, the underwater vessel 1 can bring along and release a submersible body that comprises a sound transmitter 8. The submersible body can remain underneath the water surface W after having been released.

The sound transmitter 8 of the floating body 1 is designed such that it is not active when released from the underwater vessel, i.e. the sound transmitter 8 does not transmit any sound pulses. Only after a prespecified period of time has elapsed following the release, or on detection of emerging at the water surface W, is the sound transmitter 8 activated so that sound pulses are generated and transmitted. In this way it is possible to prevent location of the underwater vessel 2 as a result of the sound pulses radiated from the sound transmitter 8.

After activation of the sound transmitter 8, the sound pulses radiated from the sound transmitter 8 can be received by the sound receiver 9 of the underwater vessel 9. The sound pulses from the sound transmitter 8 that reach the sound receiver on a direct path are illustrated in FIG. 1 by an arrow 6. By means of this direct signal, the sound receiver 8 can optionally determine the spatial direction in which the floating body 1 is located.

If a further object 3 is located in the surroundings of the sound transmitter 8, the sound pulses transmitted by the sound transmitter 8 are reflected and/or scattered at the object 3, and can be detected by the sound receiver 9. The object 3 is illustrated in FIG. 1 as an underwater vessel, while the local path of the sound pulses is suggested by the arrows 4 and 5. The design of the sound receiver 9 is directionally sensitive, so that it can determine the direction of reception, i.e. the spatial direction from which the received sound pulses originate. The sound receiver 9 is furthermore able to determine the reception time, and it is possible to determine the reception position at which the sound receiver 9 is located on receiving the sound pulse. A navigation system associated with the sound receiver 9, such as an inertial navigation system, can be provided on board the underwater vessel 2 in order to determine the reception position.

In order to be able to draw conclusions as to the position of the object 3 from the sound pulses reflected or scattered from the object 3, further information is required by the sound receiver 9. A navigation system 7 associated with the sound transmitter 8 is therefore provided, which is implemented as a satellite navigation system. The transmission position, i.e. the absolute position of the sound transmitter 8 at the time of transmission, is determined by means of the navigation system. The transmission time of the sound pulse, and the transmission position of the sound transmitter 8, are furthermore encoded at transmission time in the sound pulse in the method according to the invention. The information contained in the sound pulse is transmitted through the water, and can be decoded in the sound receiver 9 after the reflection or scattering of the sound pulse at the object 3. An additional data transmission between the sound transmitter 8 and the sound receiver 9 can thus be omitted.

A spread-spectrum method can be employed for encoding the transmission time and the transmission position in the sound pulse, whereby the decoding of the sound pulse by third parties is made more difficult.

The sound receiver 9 can determine the position of the object 3 on the basis of the transmission time and the transmission position of the sound pulse in combination with the reception time and the reception direction. The determination of position in a bistatic sonar method is sufficiently well known to the expert, and is therefore not described in detail.

In the location process, the sound receiver 9 can move with respect to the sound transmitter 8, or vice versa. The distance between the sound transmitter 8 and the sound receiver 9 should be of a similar order of magnitude to the distance between the sound transmitter 8 and the object 3, or to the distance between the object 3 to the sound receiver 9.

An alternative exemplary embodiment of the method according to the invention will be explained below with reference to the illustration of FIG. 2. In this exemplary embodiment, a plurality of sound transmitters 8, moving with respect to one another, which transmit a plurality of sound pulses, are provided. A first sound transmitter 8 is arranged on board a floating body 1, while a second sound transmitter 8 is arranged on board a surface vessel 10. Both sound transmitters 8 transmit non-directional sound pulses simultaneously, in each of which the transmission time and the transmission position are encoded. As suggested by the arrows 4 and 11, the sound pulses meet the object 3 that is to be located, and are reflected by the object 3.

The sound receiver 9 receives both the sound pulses transmitted by the first sound transmitter 8 at the floating body 1 as well as the sound pulses transmitted by the second sound transmitter 8 at the surface vessel 10. Since information on the transmission time and the transmission position is included in each of the sound pulses, the received sound pulses can each be assigned to one of the two sound transmitters 8. The position of the object 3 that is to be located can then be calculated from the information contained in the sound pulses and the reception time determined by the sound receiver 9, the reception direction, and the reception position.

In the method for locating an object 3 under water described above, a sound transmitter 8 transmits a sound pulse. The sound pulse is reflected and/or scattered at the object 3 that is to be located, and is received by a sound receiver 9 located spatially distant from the sound transmitter 8. The sound pulse contains encoded information relating to the time of transmission of the sound pulse and the transmission position of the sound transmitter 8, which is decoded by the sound receiver 9 from the sound pulse in order to determine the position of the object 3. For that reason, special apparatuses for radio reception on the part of the sound receiver, and a possible travel to periscope depth, can be omitted, so that the detectability of the sound receiver 9 by enemy units is reduced.

### LIST OF REFERENCE SIGNS

1 Floating body
2 Underwater vessel
3 Object
4 Arrow
5 Arrow
6 Arrow
7 Navigation system
8 Sound transmitter
9 Sound receiver
10 Surface vessel
11 Arrow
W Water surface

1.-11. (canceled)

12. A method for locating an object underwater, the method comprising:
transmitting with a sound transmitter a sound pulse configured to be reflected by the object to be located, wherein the sound pulse contains encoded information relating to a time of transmission of the sound pulse and a position of the sound transmitter at the time of transmission;
receiving the reflected sound pulse with a sound receiver that is spatially distant from the sound transmitter; and
decoding the encoded information to determine a position of the object.

13. The method of claim 12 wherein the time of transmission of the sound pulse and the position of the sound transmitter at the time of transmission are encoded at the time of transmission together in the one sound pulse.

14. The method of claim 12 further comprising determining with the sound receiver a reception time of the reflected sound pulse and a reception direction from which the reflected sound pulse is received.

15. The method of claim 14 further comprising determining with the sound receiver a position of the object with reference to the time of transmission, with reference to the position of the sound transmitter at the time of transmission, with reference to the reception time of the reflected sound pulse, and with reference to the reception direction of the reflected sound pulse.

16. The method of claim 12 further comprising moving the sound transmitter with respect to the sound receiver.

17. The method of claim 12 wherein the sound transmitter is disposed on a water-going vessel, an unmanned submersible, or a floating body.

18. The method of claim 17 further comprising releasing the sound transmitter from an underwater vessel.

19. The method of claim 12 further comprising releasing the sound transmitter from an underwater vessel.

20. The method of claim 12 further comprising determining the position of the sound transmitter at the time of transmission with at least one of a satellite navigation system or with an inertial navigation system.

21. The method of claim 12 wherein the sound receiver is spaced apart from the sound transmitter by an amount that is of a similar order of magnitude as a distance between the sound transmitter and the object or to a distance between the sound receiver and the object.

22. The method of claim 12 wherein the sound receiver is spaced apart from the sound transmitter by an amount that is of a similar order of magnitude as a distance between the sound transmitter and a seafloor.

23. The method of claim 12 comprising transmitting with a plurality of sound transmitters a plurality of sound pulses that are configured to be reflected by the object to be located, wherein the sound transmitter is one of the plurality of sound transmitters and the sound pulse is one of the plurality of sound pulses.

24. The method of claim 23 comprising receiving the reflected plurality of sound pulses with the sound receiver.

25. The method of claim 23 further comprising moving the plurality of sound transmitters with respect to one another.

26. A method for locating an object underwater, the method comprising:
transmitting a sound pulse configured to be reflected by the object to be located, the sound pulse containing encoded information about the transmission of the sound pulse;
receiving the sound pulse that has been reflected at a location that is spatially distant from the sound transmitter; and
decoding the encoded information.

27. The method of claim 26 wherein a sound receiver for receiving the sound pulse is spaced apart from a sound transmitter for transmitting the sound pulse by an amount that is of a similar order of magnitude as a distance between the sound transmitter and the object or a distance between the sound receiver and the object.

28. The method of claim 26 wherein the sound receiver is spaced apart from the sound transmitter by an amount that is of a similar order of magnitude as a distance between the sound transmitter and a seafloor.

29. The method of claim 26 wherein the encoded information about the transmission of the sound pulse comprises information relating to at least one of a time of transmission of the sound pulse or a position from which the sound pulse originated at the time of transmission.

30. A system for locating an object underwater, the system comprising:
a sound transmitter for transmitting a sound pulse configured to be reflected by the object to be located, wherein the sound pulse contains encoded information about the transmission; and
a sound receiver for receiving the reflected sound pulse, wherein the sound receiver is spaced apart from the sound transmitter by an amount that is of a similar order of magnitude as a distance between the sound transmitter and the object, to a distance between the sound receiver and the object, or to a distance between the sound transmitter and a seafloor, wherein the sound receiver is configured to decode the encoded information to determine a position of the object.

31. The system of claim 30 wherein the encoded information relates to a time of transmission of the sound pulse and a position of the sound transmitter at the time of transmission.
